(19) United States
(12) Patent Application Publication
(10) Pub. No.: US 2023/0082953 A1
(43) Pub. Date: Mar. 16, 2023

(54) System and Method for Real-Time Interaction and Coaching

(71) Applicant: TWENTY BILLION BEURONS GMBH, Berlin (DE)

(72) Inventors: Guillaume Jean Fernand BERGER, Toronto (CA); Roland MEMISEVIC, Toronto (CA); Antoine Clement MERCIER, Loutraki (GR)

(21) Appl. No.: 17/799,547

(22) PCT Filed: Feb. 26, 2021
(86) PCT No.: PCT/EP2021/054942

§ 371 Date: Aug. 12, 2022

Related U.S. Application Data
(60) Provisional application No. 62/982,793, filed on Feb. 28, 2020.

(51) Int. Cl. A63B 71/06; G06V 10/82; G06V 40/20; G06V 20/40; A63B 24/00

(52) U.S. Cl. CPC A63B 71/0622; G06V 10/82; G06V 40/20; G06V 20/41; G06V 20/44; A63B 24/0075; A63B 2220/05; A63B 2220/806; A63B 2225/20; A63B 2220/17; A63B 2220/62; A63B 2071/0625; A63B 2071/0694; A63B 2024/0068

(57) ABSTRACT

Methods and systems are described for real-time instruction and coaching using a virtual assistant for interaction with a user. Users may receive feedback inferences provided generally in real-time after collection of video samples from the user device. Neural network architectures and layers may be used to determine motion patterns and temporal aspects of the video samples, as well as detect activities of the foreground user despite background noise. The methods and systems may have various capabilities, including but not limited to live feedback on performed exercise activities, exercise scoring, calorie estimation, and repetition counting.

### CROSS REFERENCE TO RELATED APPLICATIONS

This application claims the benefit of U.S. Provisional Application No. 62/982,793 filed on Feb. 28, 2020, which is incorporated by reference herein in its entirety.

### FIELD

The described embodiments relate generally to a system and method for real-time interaction, and specifically to real-time exercise coaching based on video data.

### BACKGROUND

The cost of fitness coaching and/or training that is provided by a human coach is very high and out of reach for many users.

Interaction with automated virtual assistants exists in a few different forms. First, smart speakers are available such as Amazon® Alexa, Apple® Siri, and the Google® Assistant. These virtual assistants however allow only for voice-based interaction, and only recognize simple queries. Second, many service robots exist, but for the most part lack the ability for sophisticated human interactions and are basic “blind chat-bots with bodies”.

These assistants do not provide visual interaction, including visual interaction using video data from a user device. For example, existing virtual assistants do not understand a surrounding video scene, understand objects and actions in a video, understand spatial and temporal relations within a video, understand human behavior demonstrated in a video, understand and generate spoken language in a video, understand space and time as described in a video, have visually grounded concepts, reason about real-world events, have memory, or understand time.

One challenge in creating virtual assistants which provide visual interaction is the method for determining training data, since the quantitative aspects of labelling data, such as velocity labelling of video data by a human reviewer is an inherently subjective determination. This makes it difficult to label a large number of videos with such labels, in particular, when multiple individuals are involved in the process—as commonly the case when labelling large datasets.

There remains a need for an improved virtual assistant having improved interactions with humans for personal coaching, including using video interactions with a camera of a smart device such as a smartphone.

### SUMMARY

A neural network can be used for real-time instruction and coaching, if it is configured to process in real-time a camera stream that shows the user performing physical activities. Such a network can drive an instruction or coaching application by providing real-time feedback and/or by collecting information about the user's activities, such as counts or intensity measurements.

In a first aspect, there is provided a method for providing feedback to a user at a user device, the method comprising: providing a feedback model; receiving a video signal at the user device, the video signal comprising at least two video frames, a first video frame in the at least two video frames captured prior to a second frame in the at least two video frames; generating an input layer of the feedback model comprising the at least two video frames; determining a feedback inference associated with the second video frame in the at least two video frames based on the feedback model and the input layer; and outputting the feedback inference using an output device of the user device to the user.

In one or more embodiments, the feedback model may comprise a backbone network and at least one head network.

In one or more embodiments, the backbone network may be a three-dimensional convolutional neural network.

In one or more embodiments, each of the at least one head network may be a neural network.

In one or more embodiments, the at least one head network may comprise a global activity detection head network, the global activity detection head network for determining an activity classification of the video signal may be based on a layer of the backbone network; and the feedback inference may comprise the activity classification.

In one or more embodiments, the activity classification may comprise at least one selected from the group of an exercise score, a calorie estimation, and an exercise form feedback.

In one or more embodiments, the exercise score may be a continuous value determined based on a weighted sum of softmax outputs of a plurality of activity labels of the global activity detection head network.

In one or more embodiments, the at least one head network may comprise a discrete event detection head network, the discrete event detection head network for determining at least one event from the video signal based on a layer of the backbone network, each of the at least one event may comprise an event classification; and the feedback inference may comprise the at least one event.

In one or more embodiments, each event in the at least one event may further comprise a timestamp, the timestamp corresponding to the video signal; and the at least one event may correspond to a portion of a repetition of a user's exercise.

In one or more embodiments, the feedback inference may comprise an exercise repetition count.

In one or more embodiments, the at least one head network may comprise a localized activity detection head network, the localized activity detection head network for determining at least one bounding box and an activity classification corresponding to each of the at least one bounding box from the video signal based on a layer of the backbone network; and the feedback inference may comprise the at least one bounding box and the activity classification corresponding to each of the at least one bounding box.

In one or more embodiments, the feedback inference may comprise an activity classification for one or more users, the bounding boxes corresponding to the one or more users.

In one or more embodiments, the video signal may be a video stream received from a video capture device of the user device and the feedback inference may be provided in near real-time with the receiving of the video stream.

In one or more embodiments, the video signal may be a video sample received from a storage device of the user device.

In one or more embodiments, the output device may be an audio output device, and the feedback inference may be an audio cue for the user.

In one or more embodiments, the output device may be a display device, and the feedback inference may be provided as a caption superimposed on the video signal.

In a second aspect, there is provided a system for providing feedback to a user at a user device, the system comprising: a memory, the memory comprising a feedback model; an output device; a processor, the processor in communication with the memory and the output device, wherein the processor is configured to; receive, at the user device, a video signal comprising at least two video frames, a first video frame in the at least two video frames captured prior to a second frame in the at least two video frames; generate an input layer of the feedback model comprising the at least two video frames; determine a feedback inference associated with the second video frame in the at least two video frames based on the feedback model and the input layer; and output the feedback inference to the user using the output device.

In one or more embodiments, the feedback model may comprise a backbone network and at least one head network.

In one or more embodiments, the backbone network may be a three-dimensional convolutional neural network.

In one or more embodiments, each of the at least one head network may be a neural network.

In one or more embodiments, the at least one head network may comprise a global activity detection head network, the global activity detection head network for determining an activity classification of the video signal based on a layer of the backbone network; and the feedback inference may comprise the activity classification.

In one or more embodiments, the activity classification may comprise at least one selected from the group of an exercise score, a calorie estimation, and an exercise form feedback.

In one or more embodiments, the exercise score may be a continuous value determined based on a weighted sum of softmax outputs of a plurality of activity labels of the global activity detection head network.

In one or more embodiments, the at least one head network may comprise a discrete event detection head network, the discrete event detection head network for determining at least one event from the video signal based on a layer of the backbone network, each of the at least one event may comprise an event classification; and the feedback inference may comprise the at least one event.

In one or more embodiments, each event in the at least one event may further comprises a timestamp, the timestamp corresponding to the video signal; and the at least one event may correspond to a portion of a repetition of a user's exercise.

In one or more embodiments, the feedback inference may comprise an exercise repetition count.

In one or more embodiments, the at least one head network may comprise a localized activity detection head network, the localized activity detection network for determining at least one bounding box and an activity classification corresponding to each of the at least one bounding box from the video signal based on a layer of the backbone network; and the feedback inference may comprise the at least one bounding box and the activity classification corresponding to each of the at least one bounding box.

In one or more embodiments, the feedback inference may comprise an activity classification for one or more users, the bounding boxes corresponding to the one or more users.

In one or more embodiments, the video signal may be a video stream received from a video capture device of the user device and the feedback inference is provided in near real-time with the receiving of the video stream

In one or more embodiments, the video signal may be a video sample received from a storage device of the user device.

In one or more embodiments, the output device may be an audio output device, and the feedback inference is an audio cue for the user.

In one or more embodiments, the output device may be a display device, and the feedback inference may be provided as a caption superimposed on the video signal.

In a third aspect, there is provided a method for generating a feedback model, the method comprising: transmitting a plurality of video samples to a plurality of labelling users, each of the plurality of video samples comprising video data, each of the plurality of labelling users receiving at least two video samples in the plurality of video samples; receiving a plurality of ranking responses from the plurality of labelling users, each of the ranking responses indicating a relative ranking selected by the respective labelling user of the at least two video samples transmitted to the respective labelling user based upon a ranking criteria; determining an ordering label for each of the plurality of video samples based on the plurality of ranking responses and the ranking criteria; sorting the plurality of video samples into a plurality of buckets based on the respective ordering label of each video sample; determining a classification label for each of the plurality of buckets; generating the feedback model based on the plurality of buckets, the classification label of each respective bucket, and the video samples of each respective bucket.

In one or more embodiments, the generating the feedback model may comprise applying gradient based optimization to determine the feedback model.

In one or more embodiments, the feedback model may comprise at least one head network.

In one or more embodiments, each of the at least one head network may be a neural network.

In one or more embodiments, the method may further include determining that a sufficient number of the plurality of ranking responses from the plurality of labelling users have been received.

In one or more embodiments, the ranking criteria may comprise at least one selected from the group of a speed of exercise, repetition, and a range of motion.

In one or more embodiments, the ranking criteria may be associated with a particular type of physical exercise.

In a fourth aspect, there is a provided a system for generating a feedback model, the system comprising: a memory, the memory comprising a plurality of video samples; a network device; a processor in communication with the memory and the network device, the processor configured to: transmit, using the network device, the plurality of video samples to a plurality of labelling users, each of the plurality of video samples comprising video data, each of the plurality of labelling users receiving at least two video samples in the plurality of video samples; receive, using the network device, a plurality of ranking responses from the plurality of labelling users, each of the ranking responses indicating a relative ranking selected by the respective labelling user of the at least two video samples transmitted to the respective labelling user based upon a ranking criteria; determine an ordering label for each of the plurality of video samples based on the plurality of ranking responses and the ranking criteria; sort the plurality of video samples into a plurality of buckets based on the respective ordering label of each video sample; determine a classification label for each of the plurality of buckets; generate the feedback model based on the plurality of buckets, the classification label of each respective bucket, and the video samples of each respective bucket.

In one or more embodiments, the processor may be further configured to apply gradient based optimization to determine the feedback model.

In one or more embodiments, the feedback model may comprise at least one head network.

In one or more embodiments, each of the at least one head network may be a neural network.

In one or more embodiments, the processor may be further configured to: determine that a sufficient number of the plurality of ranking responses from the plurality of labelling users have been received.

In one or more embodiments, the ranking criteria may comprise at least one selected from the group of a speed of exercise, repetition, and a range of motion.

In one or more embodiments, the ranking criteria may be associated with a particular type of physical exercise.

### BRIEF DESCRIPTION OF THE DRAWINGS

A preferred embodiment of the present invention will now be described in detail with reference to the drawings, in which:

FIG. 1 is a system diagram for a user device for real-time interaction and coaching in accordance with one or more embodiments;

FIG. 2 is a method diagram for real-time interaction and coaching in accordance with one or more embodiments;

FIG. 3 is a scenario diagram for real-time interaction and coaching in accordance with one or more embodiments;

FIG. 4 is a user interface diagram for real-time interaction and coaching including a virtual avatar in accordance with one or more embodiments;

FIG. 5 is a user interface diagram for real-time interaction and coaching in accordance with one or more embodiments;

FIG. 6 is a user interface diagram for real-time interaction and coaching in accordance with one or more embodiments;

FIG. 7 is another user interface diagram for real-time interaction and coaching in accordance with one or more embodiments;

FIG. 8 is a table diagram for exercise scoring in accordance with one or more embodiments;

FIG. 9 is another table diagram for exercise scoring in accordance with one or more embodiments;

FIG. 10 is a system diagram for generating a feedback model in accordance with one or more embodiments;

FIG. 11 is a method diagram for generating a feedback model in accordance with one or more embodiments;

FIG. 12 is a model diagram for determining feedback inferences in accordance with one or more embodiments;

FIG. 13 is a steppable convolution diagram for determining feedback inferences in accordance with one or more embodiments;

FIG. 14 is a user interface diagram for temporal labelling for generating a feedback model in accordance with one or more embodiments;

FIG. 15 is a user interface diagram for pairwise labelling for generating a feedback model in accordance with one or more embodiments;

FIG. 16 is a comparison of pairwise ranking labels with the accuracy of human annotated ranking, where the pairwise rankings were produced by comparing each video to 10 other videos;

FIG. 17 is another user interface for real-time interaction and coaching in accordance with one or more embodiments.

### DESCRIPTION OF EXEMPLARY EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smartphone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented such as hardware, software, and combinations thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

As described herein, the term “real-time” refers to generally real-time feedback from a user device to a user. The term “real-time” herein may include a short processing time, for example 100 ms to 1 second, and the term “real-time” may mean “approximately in real-time” or “near real-time”.

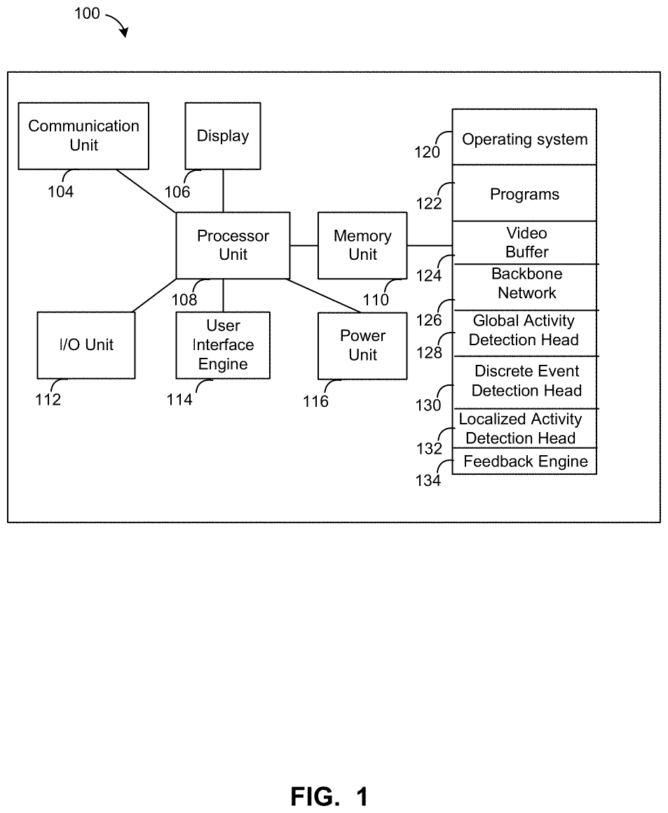

Reference is first made to FIG. 1, which shows a system diagram for a user device 100 for real-time interaction and coaching in accordance with one or more embodiments. The user device 100 includes a communication unit 104, a processor unit 108, a memory unit 110, I/O unit 112, a user interface engine 114, and a power unit 116. The user device 100 has a display 106, which may also be a user input device such as a capacitive touch sensor integrated with the screen.

The processor unit 108 controls the operation of the user device 100. The processor unit 108 can be any suitable processor, controller or digital signal processor that can provide sufficient processing power depending on the configuration, purposes and requirements of the user device 100 as is known by those skilled in the art. For example, the processor unit 108 may be a high-performance general processor. In alternative embodiments, the processor unit 108 can include more than one processor with each processor being configured to perform different dedicated tasks. In alternative embodiments, it may be possible to use specialized hardware to provide some of the functions provided by the processor unit 108. For example, the processor unit 108 may include a standard processor, such as an Intel® processor, an ARM® processor or a microcontroller.

The communication unit 104 can include wired or wireless connection capabilities. The communication unit 104 can include a radio that communicates utilizing 4G, LTE, 5G, CDMA, GSM, GPRS or Bluetooth protocol according to standards such as IEEE 802.11a, 802.11b, 802.11g, or 802.11n, etc. The communication unit 104 can be used by the user device 100 to communicate with other devices or computers.

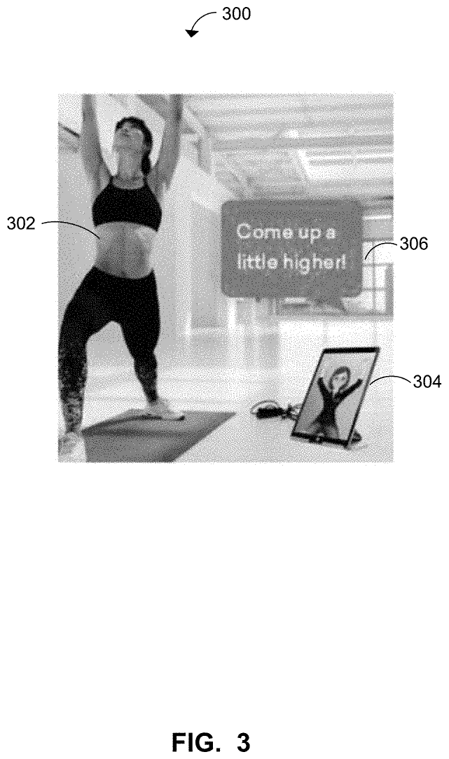

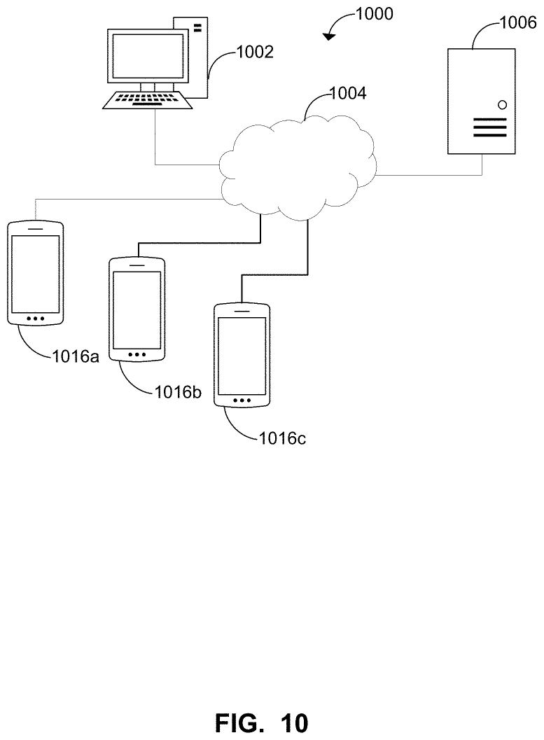

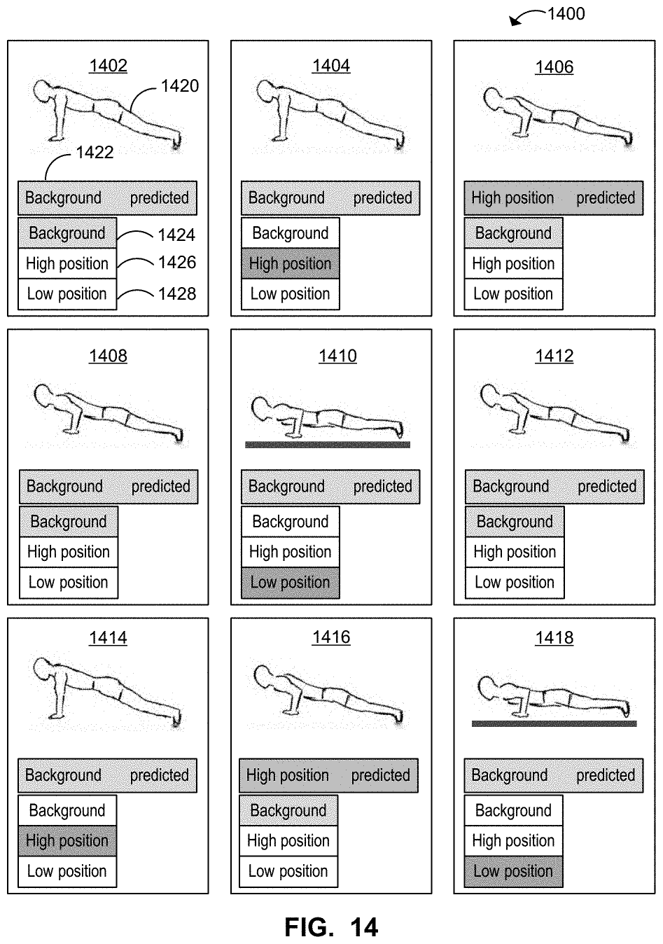

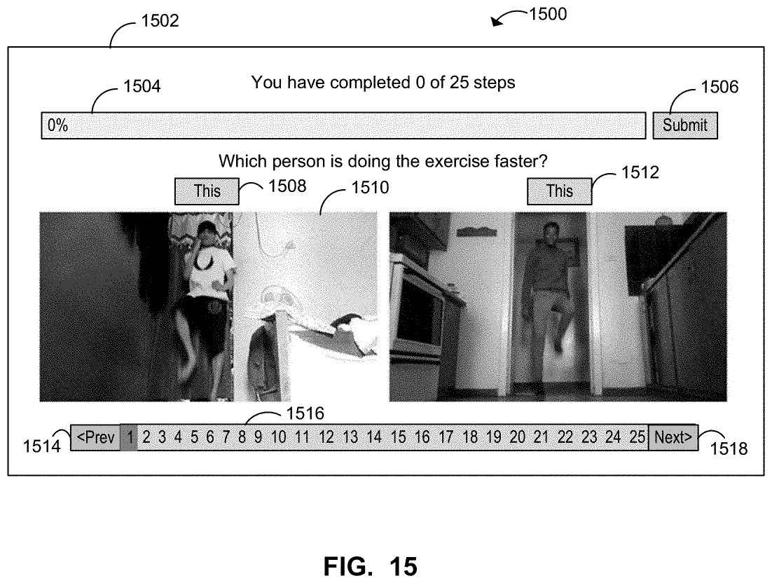

The processor unit 108 can also execute a user interface engine 114 that is used to generate various user interfaces, some examples of which are shown and described herein, such as interfaces shown in FIGS. 3, 4, 5, 6, and 7. Optionally, where the user device is one such as 1016 in FIG. 10, user interfaces such as FIGS. 14 and 15 may be generated.

The user interface engine 114 is configured to generate interfaces for users to receive feedback inferences while performing physical activity, weightlifting, or other types of actions. The feedback inferences may be provided generally in real-time with the collection of a video signal by the user device. The feedback inferences may be superimposed by the user interface engine 114 on a video signal received by the I/O unit 112. Optionally, the user interface engine 114 may provide user interfaces for labelling of video samples. The various interfaces generated by the user interface engine 114 are displayed to the user on display 106.

The display 106 may be an LED or LCD based display and may be a touch sensitive user input device that supports gestures.

The I/O unit 112 can include at least one of a mouse, a keyboard, a touch screen, a thumbwheel, a track-pad, a track-ball, a card-reader, voice recognition software and the like again depending on the particular implementation of the user device 100. In some cases, some of these components can be integrated with one another.

The I/O unit 112 may further receive a video signal from a video input device such as a camera (not shown) of the user device 100. The camera may generate a video signal of a user using a user device while performing actions such as physical activity. The camera may be a CMOS active-pixel image sensor, or the like. The format of the video signal from the image input device may be provided in a 3GP format using an H.263 encoder to the video buffer 124.

The power unit 116 can be any suitable power source that provides power to the user device 100 such as a power adaptor or a rechargeable battery pack depending on the implementation of the user device 100 as is known by those skilled in the art.

The memory unit 110 comprises software code for implementing an operating system 120, programs 122, video buffer 124, backbone network 126, global activity detection head 128, discrete event detection head 130, localized activity detection head 132, feedback engine 134.

The memory unit 110 can include RAM, ROM, one or more hard drives, one or more flash drives or some other suitable data storage elements such as disk drives, etc. The memory unit 110 is used to store an operating system 120 and programs 122 as is commonly known by those skilled in the art. For instance, the operating system 120 provides various basic operational processes for the user device 100. For example, the operating system 120 may be a mobile operating system such as Google® Android operating system, or Apple® iOS operating system, or another operating system.

The programs 122 include various user programs so that a user can interact with the user device 100 to perform various functions such as, but not limited to, interacting with the user device, recording a video signal with the camera, and displaying information and notifications to the user.

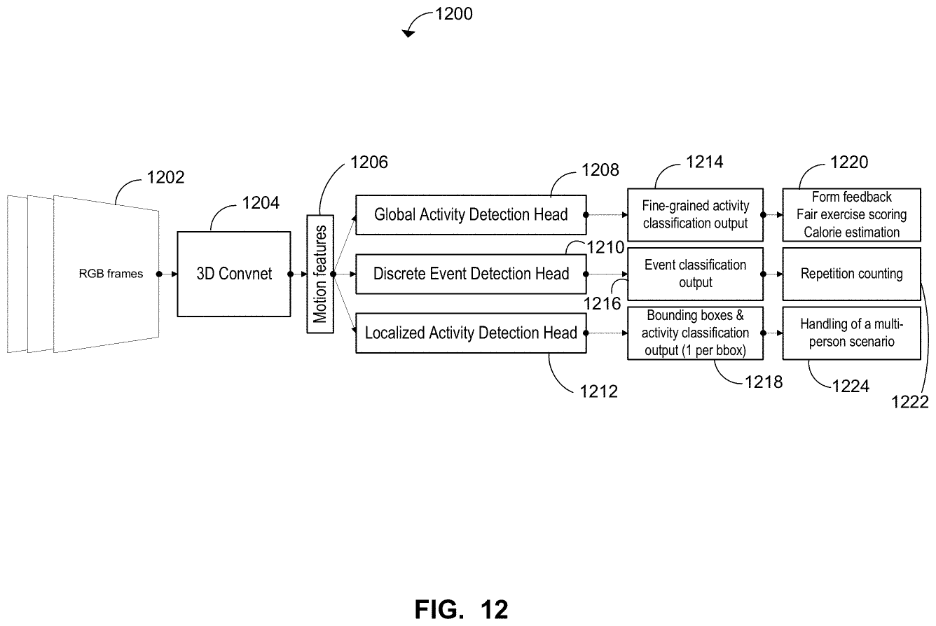

The backbone network 126, global activity detection head 128, discrete event detection head 130, and localized activity detection head 132 may be provided to the user device 100 as a software application from the Apple® AppStore® or the Google® Play Store®. The backbone network 126, global activity detection head 128, discrete event detection head 130, and localized activity detection head 132 are described in more detail in FIG. 12.

The video buffer 124 receives video signal data from the I/O unit 112 and stores it for use by the backbone network 126, the global activity detection head 128, the discrete event detection head 130, and the localized activity detection head 132. The video buffer 124 may receive streaming video signal data from a camera device via the I/O unit 112, or may receive video signal data stored on a storage device of the user device 100.

The buffer 124 may allow for rapid access to the video signal data. The buffer 124 may have a fixed size and may replace video data in the buffer 124 using a first in, first out replacement policy.

The backbone network 126 may be a machine learning model. The backbone network 126 may be pre-trained and may be provided in the software application that is provided to user device 100. The backbone network 126 may be, for example, a neural network such as a convolutional neural network. The convolutional neural network may be a three-dimensional neural network. The convolutional neural network may be a steppable convolutional neural network. The backbone network may be the backbone network 1204 (see FIG. 12).

The global activity detection head 128 may be a machine learning model. The global activity detection head 128 may be pre-trained and may be provided in the software application that is provided to user device 100. The global activity detection head 128 may be, for example, a neural network such as a convolutional neural network. The convolutional neural network may be a three-dimensional neural network. The convolutional neural network may be a steppable convolutional neural network. The global activity detection head 128 may be the global activity detection head 1208 (see FIG. 12).

The discrete event detection head 130 may be a machine learning model. The discrete event detection head 130 may be pre-trained and may be provided in the software application that is provided to user device 100. The discrete event detection head 130 may be, for example, a neural network such as a convolutional neural network. The convolutional neural network may be a three-dimensional neural network. The convolutional neural network may be a steppable convolutional neural network. The discrete event detection head 130 may be the discrete event detection head 1210 (see FIG. 12).

The localized activity detection head 132 may be a machine learning model. The localized activity detection head 132 may be pre-trained and may be provided in the software application that is provided to user device 100. The localized activity detection head 132 may be, for example, a neural network such as a convolutional neural network. The convolutional neural network may be a three-dimensional neural network. The convolutional neural network may be a steppable convolutional neural network. The localized activity detection head 132 may be the localized activity detection head 1212 (see FIG. 12).

The feedback engine 134 may cooperate with the backbone network 126, global activity detection head 128, discrete event detection head 130, and localized activity detection head 132 to generate feedback inferences for a user performing actions in view of a video input device of user device 100.

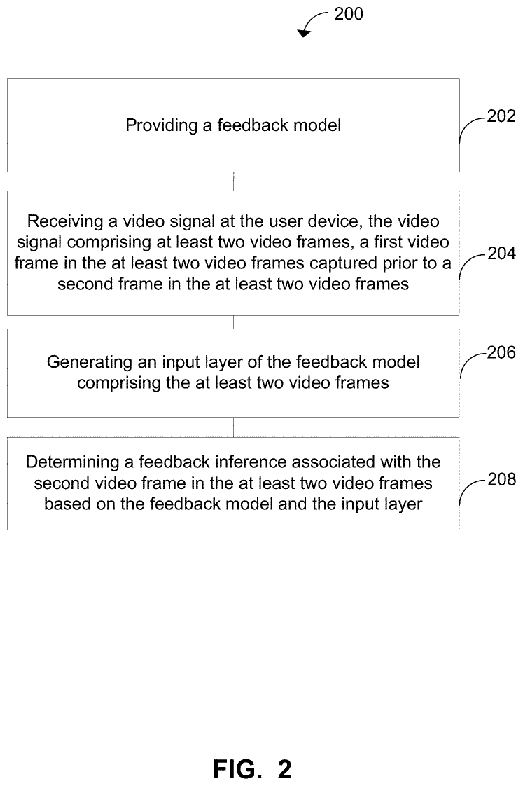

The feedback engine 134 may perform the method of FIG. 2 in order to determine feedback for users based on their actions in view of a video input device of user device 100.

The feedback engine 134 may generate feedback for the user of user device 100, including audio, audiovisual, and visual feedback. The feedback created may include cues for the user to improve their physical activity, feedback on the form of their physical activity, exercise scoring indicating how successfully the user is performing an exercise, calorie estimation of the exertion of the user, repetition counting of the user's activity. Further, the feedback engine 134 may provide feedback for multiple users in view of the video input device connected to I/O unit 112.

Referring next to FIG. 2, there is shown a method diagram 200 for real-time interaction and coaching in accordance with one or more embodiments.

The method 200 for real-time interaction and coaching may include outputting a feedback inference to a user at a user device, including via audio or visual cues. In order to determine the feedback inferences, a video signal may be received that may be processed by the feedback engine using feedback model (see FIG. 12).

The method 200 may provide generally real-time feedback on activities or exercise performed by the user. The feedback may be provided by an avatar or superimposed on the video signal of the user such that they can see and correct their exercise form. For example, feedback may include pose information for the user so that they can correct a pose based on the collected video signal, or feedback on an exercise that is based on the collected video signal. This may be useful for coaching, where a “trainer” avatar provides live feedback on form and other aspects of how the activity (e.g., exercise) is performed.

At 202, providing a feedback model.

At 204, receiving a video signal at the user device, the video signal comprising at least two video frames, a first video frame in the at least two video frames captured prior to a second frame in the at least two video frames.

At 206, generating an input layer of the feedback model comprising the at least two video frames.

At 208, determining a feedback inference associated with the second video frame in the at least two video frames based on the feedback model and the input layer.

In one or more embodiments, the feedback inference may be output using an output device of the user device to the user.

In one or more embodiments, the feedback model may comprise a backbone network and at least one head network. The model architecture is described in further detail at FIG. 12.

In one or more embodiments, the backbone network may be a three-dimensional convolutional neural network.

In one or more embodiments, each of the at least one head network may be a neural network.

In one or more embodiments, the at least one head network may comprise a global activity detection head network, the global activity detection head network for determining an activity classification of the video signal based on a layer of the backbone network; and the feedback inference may comprise the activity classification.

In one or more embodiments, the activity classification may comprise at least one selected from the group of an exercise score, a calorie estimation, and an exercise form feedback.

In one or more embodiments, the feedback inference may comprise a repetition score, the repetition score may be determined based on the activity classification and an exercise repetition count received from a discrete event detection head; and wherein the activity classification may comprise an exercise score

In one or more embodiments, the exercise score may be a continuous value determined based on an inner product between a vector of softmax outputs across a plurality of activity labels and a vector of scalar reward values across the plurality of activity labels.

In one or more embodiments, the at least one head network may comprise a discrete event detection head network (see e.g., FIG. 12), the discrete event detection head network for determining at least one event from the video signal based on a layer of the backbone network, each of the at least one event may comprise an event classification; and the feedback inference comprises the at least one event.

In one or more embodiments, each event in the at least one event may further comprise a timestamp, the timestamp corresponding to the video signal; and the at least one event corresponding to a portion of a repetition of a user's exercise.

In one or more embodiments, the feedback inference may comprise an exercise repetition count.

In one or more embodiments, the at least one head network may comprise a localized activity detection head network (see FIG. 12), the localized activity detection head network for determining at least one bounding box and an activity classification corresponding to each of the at least one bounding box from the video signal based on a layer of the backbone network; and the feedback inference may comprise the at least one bounding box and the activity classification corresponding to each of the at least one bounding box.

In one or more embodiments, the feedback inference may comprise an activity classification for one or more users, the bounding boxes corresponding to the one or more users.

Referring next to FIG. 3, there is shown a scenario diagram 300 for real-time interaction and coaching in accordance with one or more embodiments.

The scenario diagram 300 shown provides an example view of the use of a software application on a user device for assistance with exercise activities. A user 302 operates a user device 304 running a software application that includes the feedback model described in FIG. 12 as shown. The user device 304 captures a video signal that is processed by the feedback model in order to generate a feedback inference, such as form feedback 306. The associated feedback inference 306 is output to the user 302 while the user 302 is performing the activity, and generally in real-time. The output may be in the form of an audio cue for the user 302, a message from a virtual assistant or avatar, or a caption superimposed on the video signal.

The user device 304 may be provided by a fitness center, a fitness instructor, the user 302 themselves, or another individual, group or business. The user device 304 may be used in a fitness center, at home, outside, or anywhere the user 302 may use the user device 304.

The software application of the user device 304 may be used to provide feedback regarding exercises completed by the user 302. The exercises may be yoga, Pilates, weight training, body-weight exercises, or another physical exercise. The software application may obtain video signals from a video input device or camera of the user device 304 of the user 302 while they complete the exercise. The provided feedback may provide feedback to the user 302 to indicate repetition number, set number, positive encouragement, available exercise modifications, corrections to form, speed of repetition, angle of body parts, width of step or body placement, depth of exercise, or other types of feedback.

The software application may provide information to the user 302 in the form of feedback to improve the form of user 302 during the exercise. The output may include corrections to limb placement, hold duration, body positioning, or other corrections that may only be obtained where the software application can detect body placement of the user 302 through the video signal from the user device 304.

The software application may provide the user 302 with a feedback inference 306 in the form of an avatar, virtual assistant, and the like. The avatar may provide the user 302 with visual representations of appropriate body and limb placement, exercise modifications to increase or decrease difficulty level, or other visual representations. The feedback inference 306 may further include audio cues for the user 302.

The software application may provide the user 302 with a feedback inference 306 in the form of the video signal taken by the camera of the user device 304. The video signal may have the feedback inference 306 superimposed over the video signal, where the feedback inference 306 includes one or more of the above-mentioned feedback options.

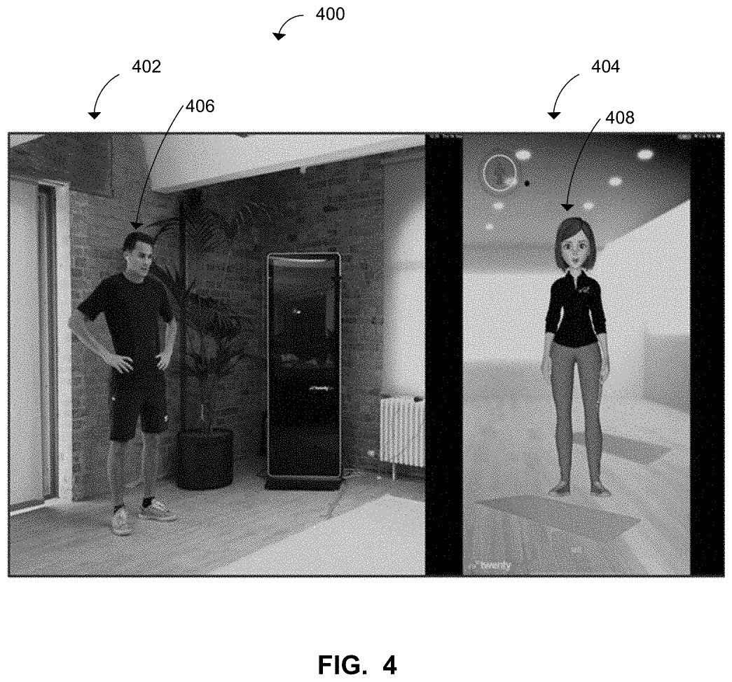

Referring next to FIG. 4, there is shown a scenario diagram 400 for real-time interaction and coaching including a virtual avatar 408 in accordance with one or more embodiments. A room 402 is shown to embody a user 406 while using the software application on a user device 404, while the user device 404 represents what is output to the user 406 from the user device 404.

The user 406 may operate the software application on a user device 404 that includes the feedback model described in FIG. 12 as shown. The user device 404 captures a video signal that is processed by the feedback model in order to generate a virtual avatar 408. The virtual avatar 408 may be output to the user 406 to lead the user 406 through an exercise routine, individual exercises, and the like. The virtual avatar 408 may also provide the user 406 with feedback such as repetition number, set number, positive encouragement, available exercise modifications, corrections to form, speed of repetition, angle of body parts, width of step or body placement, depth of exercise, or other types of feedback. The feedback (not shown) provided to the user 406 through the user device 404 may be a visual representation or an audio representation.

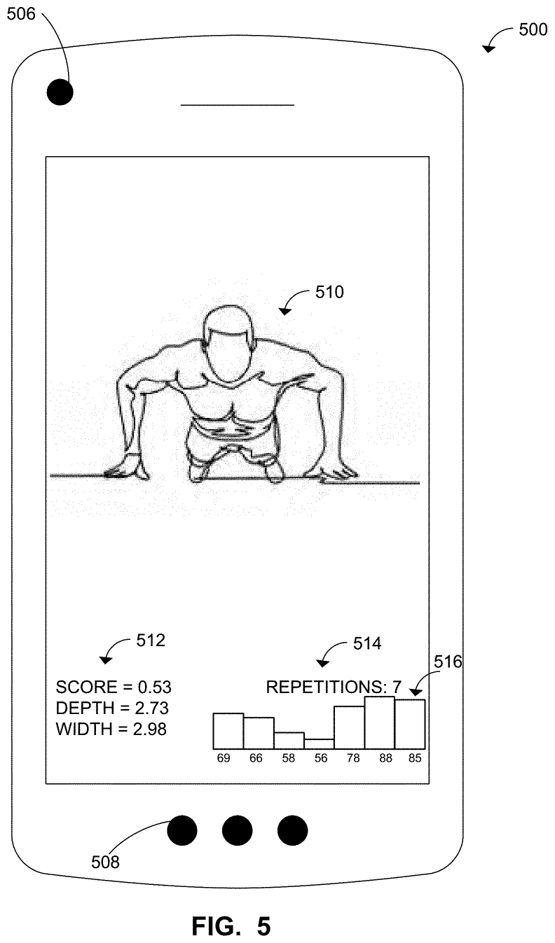

Referring next to FIG. 5, there is shown a user interface diagram 500 for real-time interaction and coaching in accordance with one or more embodiments.

A user 510 operates the user interface 500 running a software application that includes the feedback model described in FIG. 12 as shown. The user interface 500 captures a video signal through the camera 506 that is processed by the feedback model and may generate a feedback inference 514 and an activity classification 512. The associated feedback inference 514 and activity classification 512 may be output to the user 510 during and/or after the user 510 is performing the activity. The output may be a caption superimposed on the video signal as shown.

The video signal may be processed by the global activity detection head and the discrete event detection head to generate the feedback inference 514 and the activity classification 512, respectively. The feedback inference may include repetition counting, width of step or body placement, or other types of feedback as previously described. The activity classification may include form feedback, fair exercise scoring, and/or calorie estimation. The global activity detection head and the discrete event detection head may define the movement of the user 510 to output a visual representation of movement 516.

The user interface 500 may provide the user 510 with an output in the form of the video signal taken by the camera 506 of the user interface 500. The video signal may have the feedback inference 514, the activity classification 512 and/or the visual representation of movement 516 superimposed over the video signal.

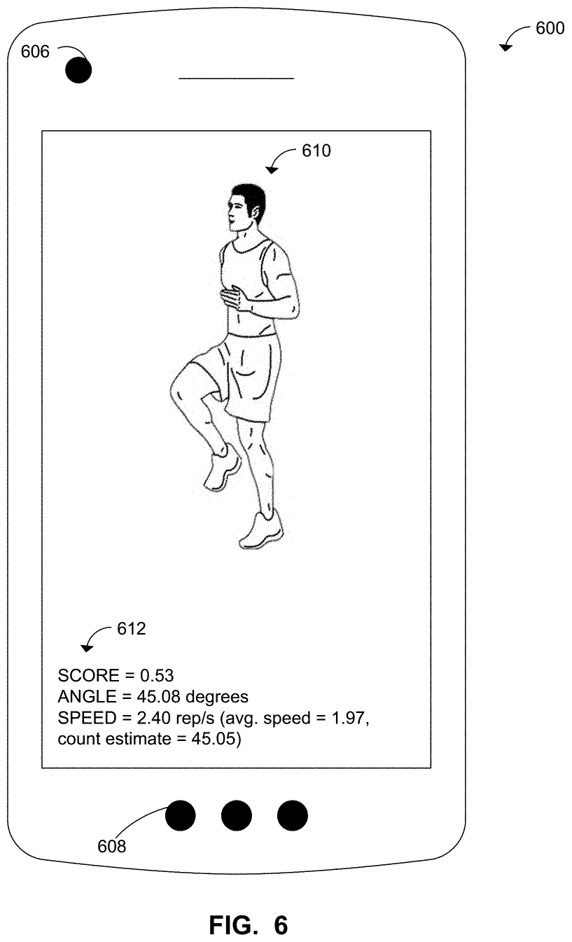

Referring next to FIG. 6, there is shown a user interface diagram 600 for real-time interaction and coaching in accordance with one or more embodiments.

A user 610 operates the user interface 600 running a software application that includes the feedback model described in FIG. 12 as shown. The user interface 600 captures a video signal through the camera 606 that is processed by the feedback model and may generate an activity classification 612. The activity classification 612 may be output to the user 610 during and/or after the user 610 is performing the activity. The output may be a caption superimposed on the video signal.

The video signal may be processed by the discrete event detection head to generate the activity classification 612. The activity classification may include fair exercise scoring, calorie estimation, and/or form feedback such as angle of body placement, speed of repetition, or other types of feedback as previously described.

The user interface 600 may provide the user 610 with an output in the form of the video signal taken by the camera 606 of the user interface 600. The video signal may have the activity classification 612 superimposed over the video signal.

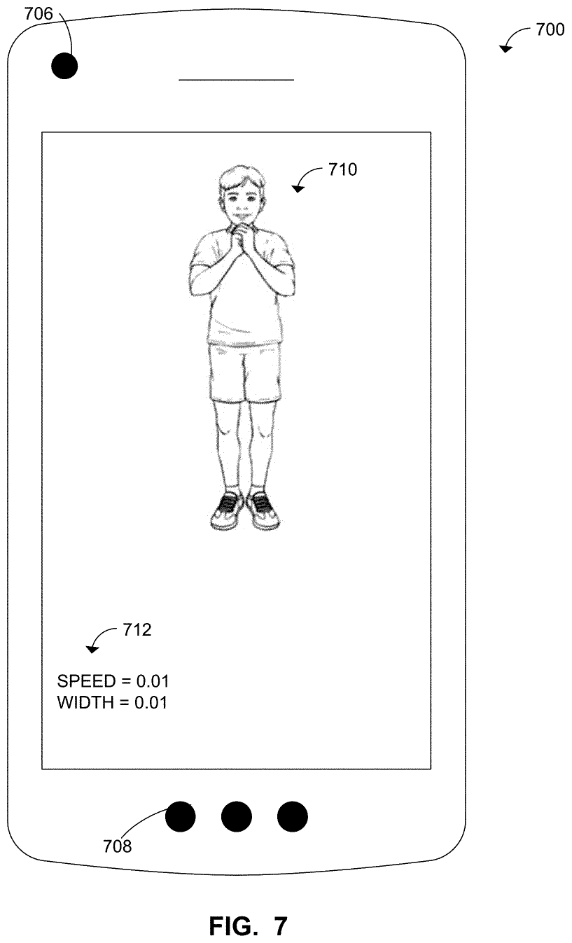

Referring next to FIG. 7, there is shown another user interface diagram 700 for real-time interaction and coaching in accordance with one or more embodiments.

A user 710 operates the user interface 700 running a software application that includes the feedback model described in FIG. 12 as shown. The user interface 700 captures a video signal through the camera 706 that is processed by the feedback model and may generate an activity classification 712. The activity classification 712 may be output to the user 710 during and/or after the user 710 is performing the activity. The output may be a caption superimposed on the video signal.

The video signal may be processed by the discrete event detection head to generate the activity classification 712. The activity classification may include fair exercise scoring, calorie estimation, and/or form feedback such as width of step or body placement, speed of repetition, or other types of feedback as previously described.

The user interface 700 may provide the user 710 with an output in the form of the video signal taken by the camera 706 of the user interface 700. The video signal may have the activity classification 712 superimposed over the video signal.

Referring next to FIG. 10, there is shown a system diagram 1000 for generating a feedback model in accordance with one or more embodiments. The system may have a facilitator device 1002, a network 1004, a server 1006, and user devices 1016. While three user devices 1016 are shown, there may be many more than three.

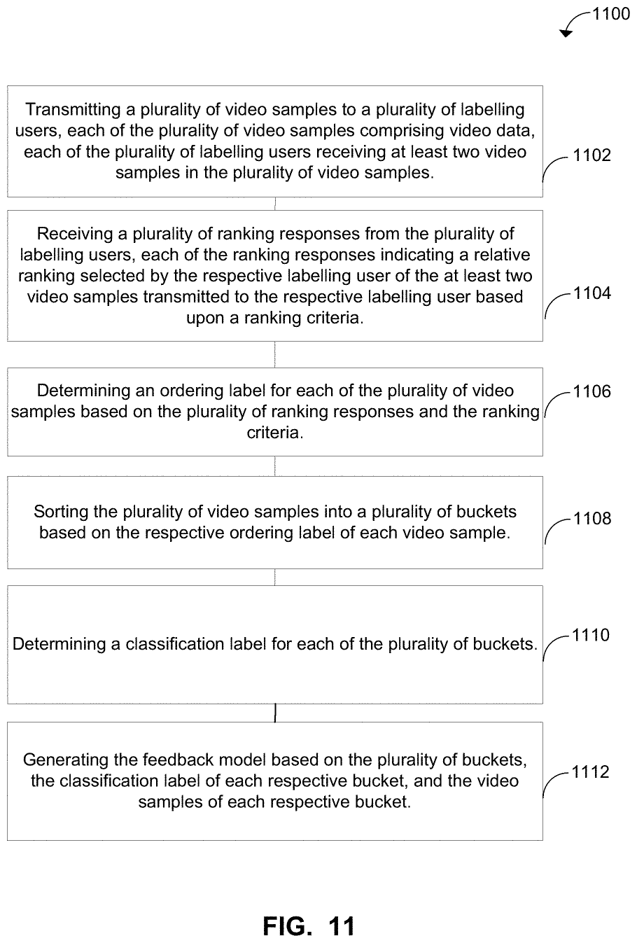

The user devices 1016 may generally correspond to the same type of user devices as in FIG. 1, except wherein the downloaded software application includes a labelling engine instead of the backbone network 126, activity heads 128, 130, and 132, and feedback engine 134. The labelling engine may be used by a labelling user at user device 1016 (see FIG. 10). The user device 1016 having the labelling engine may be referred to as a labelling device 1016. The labelling engine may be downloadable from an app store, such as the Google® Play Store® or the Apple® AppStore®. The server 1006 may operate the method of FIG. 11 in order to generate a feedback model based upon the labelling data from the user devices 1016.

Labelling users (not shown) may each operate user devices 1016a to 1016c in order to label training data, including video sample data. The user devices 1016 are in network communication with the server 1006. The users may send or receive training data, including video sample data and labelling data, to the server 1006.

Network 1004 may be any network or network components capable of carrying data including the Internet, Ethernet, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

A facilitator device 1002 may be any two-way communication device with capabilities to communicate with other devices, including mobile devices such as mobile devices running the Google® Android® operating system or Apple® iOS® operating system. The facilitator device 1002 may allow for the management of the model generation at server 1006, and the delegation of training data, including video sample data to the user devices 1016.

Each user device 1016 includes and executes a software application, such as the labelling engine, to participate in data labelling. The software application may be a web application provided by server 1006 for data labelling, or it may be an application installed on the user device 1016, for example, via an app store such as Google® Play® or the Apple® App Store®

As shown, the user devices 1016 are configured to communicate with server 1006 using network 1004. For example, server 1006 may provide a web application or Application Programming Interface (API) for an application running on user devices 1016.

The server 1006 is any networked computing device or system, including a processor and memory, and is capable of communicating with a network, such as network 1004. The server 1006 may include one or more systems or devices that are communicably coupled to each other. The computing device may be a personal computer, a workstation, a server, a portable computer, or a combination of these.

The server 1006 may include a database for storing video sample data and labelling data received from the labelling users at user devices 1016.

The database may store labelling user information, video sample data, and other related information. The database may be a Structured Query Language (SQL) such as PostgreSQL or MySQL or a not only SQL (NoSQL) database such as MongoDB, or Graph Databases etc.

Referring next to FIG. 11, there is shown a method diagram 1100 for generating a feedback model in accordance with one or more embodiments.

Generation of a feedback model may involve training of a neural network. Training of the neural network may use video clips labeled with activities or other information about the content of video. For training, both “global” labels and “local” labels may be used. Global labels may contain information about multiple (or all) frames within a training video clip (for example, an activity performed in the clip). Local labels may contain temporal information assigned to a particular frame within the clip, such as the beginning or the end of an activity.

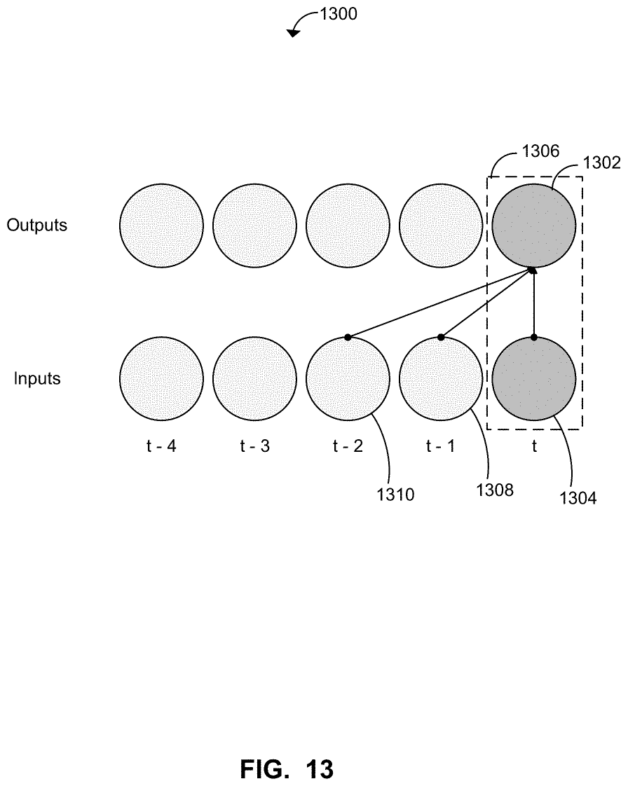

In real-time applications, such as coaching, three-dimensional convolutions may be used. Each three-dimensional convolution may be turned into a “steppable” module at inference time, where each frame may be processed only once. During training, three-dimensional convolutions may be applied in a “causal” manner. The “causal” manner may refer to the fact that in the convolutional neural network, no information from the future may leak into the past (see e.g., FIG. 13 for further detail). This may also involve the training of the discrete event detection head, which needs to identify activities at precise positions in time.

At 1102, transmitting a plurality of video samples to a plurality of labelling users, each of the plurality of video samples comprising video data, each of the plurality of labelling users receiving at least two video samples in the plurality of video samples.

At 1104, receiving a plurality of ranking responses from the plurality of labelling users, each of the ranking responses indicating a relative ranking selected by the respective labelling user of the at least two video samples transmitted to the respective labelling user based upon a ranking criterion.

At 1106, determining an ordering label for each of the plurality of video samples based on the plurality of ranking responses and the ranking criteria.

At 1108, sorting the plurality of video samples into a plurality of buckets based on the respective ordering label of each video sample.

At 1110, determining a classification label for each of the plurality of buckets.

At 1112, generating the feedback model based on the plurality of buckets, the classification label of each respective bucket, and the video samples of each respective bucket.

In one or more embodiments, the generating the feedback model may comprise applying gradient based optimization to determine the feedback model.

In one or more embodiments, the feedback model may comprise at least one head network.

In one or more embodiments, each of the at least one head network may be a neural network.

In one or more embodiments, the method may further comprise determining that a sufficient number of the plurality of ranking responses from the plurality of labelling users have been received.

In one or more embodiments, the ranking criteria may comprise at least one selected from the group of a speed of exercise, repetition, and a range of motion.

In one or more embodiments, the ranking criteria may be associated with a particular type of physical exercise.

The method 1100 may describe a pair-wise labelling method. In many interactive applications, in particular related to coaching, it may be useful to train a recognition head on labels that correspond to a linear order (or ranking). For example, the network may provide outputs related to the velocity with which an exercise is performed. Another example is the recognition of the range of motion when performing a movement. Similar to other types of labels, labels corresponding to a linear order may be generated for given videos by human labelling.

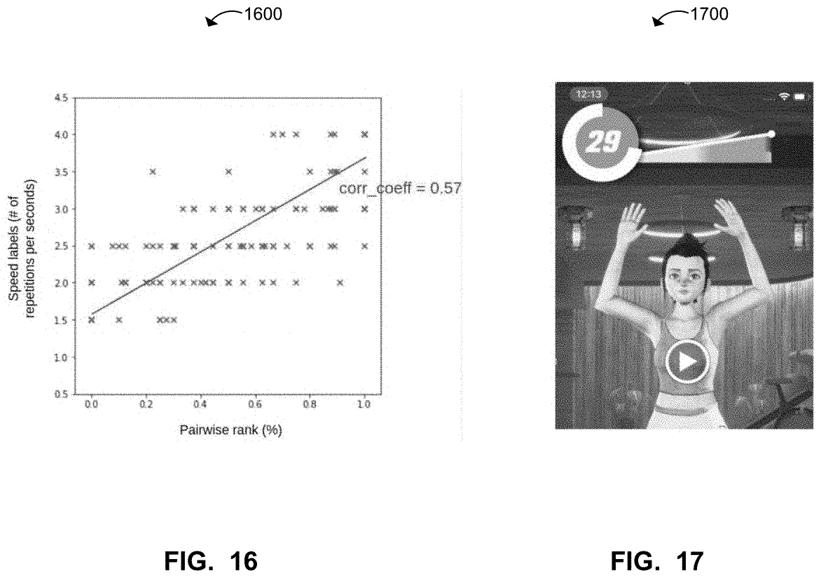

Pair-wise labelling allows for a labelling user to label two videos, v₁ and v₂, at a time and providing only relative judgements regarding the order. For example, in the case of a velocity-label, labelling could amount to determining if v₁>v₂ (velocity shown in the motion in video v₁ is higher than velocity shown in the motion in video v₂) or vice versa. Given a sufficiently large number of such pair-wise labels, a dataset of examples may be sorted. In practice, comparing every video to 10 other videos is usually sufficient to produce rankings that correlate well with human judgement (see e.g., FIG. 16). Individual video ranks can then be grouped into an arbitrary number of buckets and each bucket can be assigned a classification label.

Referring next to FIG. 12, there is shown a model diagram 1200 for determining feedback inferences in accordance with one or more embodiments. The model 1200 may be a neural network architecture and may receive as input two or more video frames 1202 from a video signal. The model 1200 has a backbone network 1204 which may preferably be a three-dimensional convolutional neural network that generates motion features 1206 which are the input to one or more detection heads, including global activity detection head 1208, discrete event detection head 1210, and localized activity detection head 1212.

Since most visual concepts in video signals are related with one another, a common neural network structure such as the one shown in model 1200 may exploit commonalities through transfer learning and may include a shared backbone network 1204 and individual, task-specific heads 1208, 1210, and 1212. Transfer learning may include the determination of motion features 1206 which may be used to extend the capabilities of the model 1200, since the backbone network 1204 may be re-used for processing the video signals as they are received, and further to train new detection heads on top.

The backbone network 1204 receives at least one video frame 1202 from a video signal. The backbone network 1204 may be a shared backbone network on top of which multiple heads are jointly trained. The model 1200 may have an architecture that is trained end-to-end, having video frames including pixel data as input and activity labels as output (instead of making use of bounding boxes, pose estimation or a form of frame-by-frame analysis as an intermediate representation). The backbone network 1204 may perform steppable convolution as described in FIG. 13.

Each head network 1208, 1210, and 1212 may be a neural network, with 1, 2 or more fully connected layers.

The global activity detection head 1208 is connected to a layer of the backbone network 1204 and generates fine grained activity classification output 1214 which may be used to provide a user with feedback 1220, including form feedback inferences, exercise scoring inferences, and calorie estimation inferences.

Feedback inferences 1220 may be associated with a single output neuron of a global activity detection head 1208, and a threshold may be applied above which the corresponding form feedback will be triggered. In other cases, the softmax value of multiple neurons may be summed to provide feedback.

The merging may occur when the classification output 1214 of the detection head 1208 is more fine-grained than necessary for a given feedback (In other words, when multiple neurons correspond to multiple different variants of performing the activity).

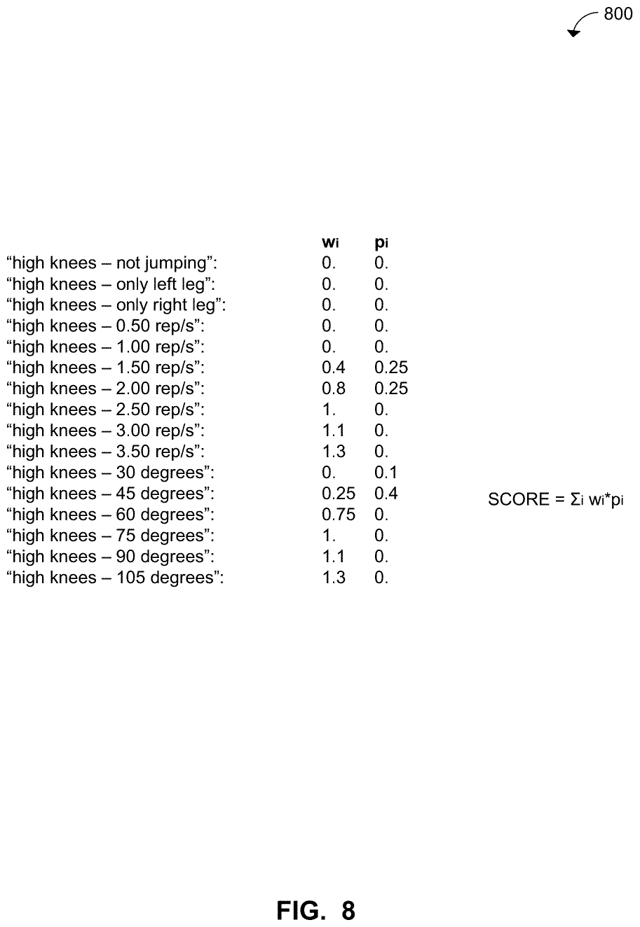

One type of feedback inference 1220 is an exercise score. In order to score fairly a user performing a certain exercise, the multivariate classification output 1214 of the feedback model 1208 may be converted into a single continuous value by computing the inner product between the vector of softmax outputs (pᵢ in FIG. 8) across classes and a “reward” vector that associates a scalar reward value (wᵢ in FIG. 8) with each class. More specifically, each activity label that is relevant for the considered exercise may be assigned a weight (see FIG. 8). Labels that correspond to the proper form (or higher intensity) may receive higher rewards while labels that correspond to poor form may get lower rewards. As a result, the inner product may correlate with form, intensity, etc.

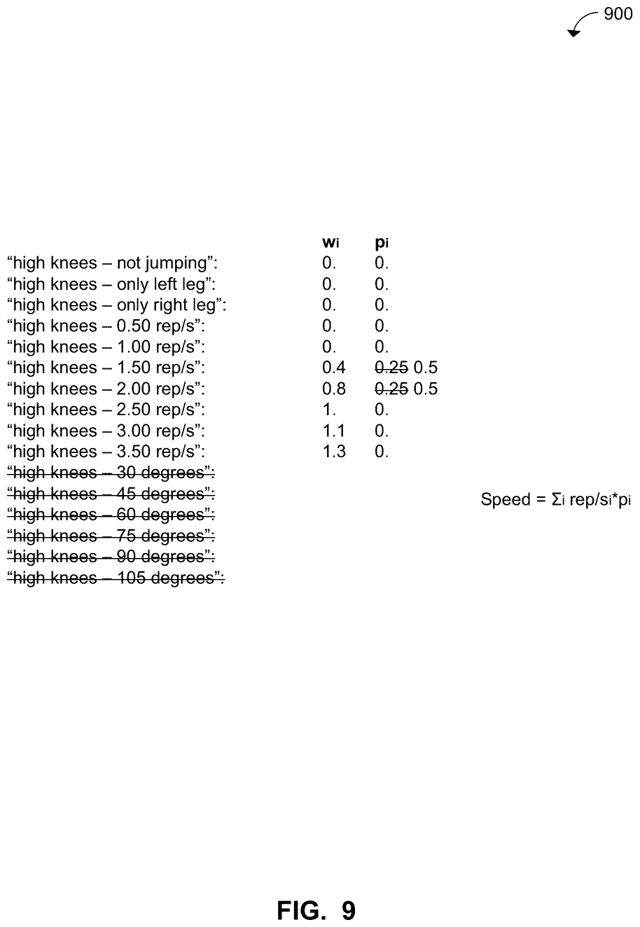

Referring to FIGS. 8 and 9, there are shown table diagrams illustrating this in the context of scoring the form accuracy and intensity of “high knees”, where wᵢ corresponds the reward weight and pᵢ corresponds to the classification output. Specifically, FIG. 8 illustrates this for an overall reward that takes into account form, speed and intensity, and FIG. 9 illustrates this for a reward that takes into account only the speed of performing the exercise.

The scoring approach of FIGS. 8 and 9 may be used to score metrics other than form, including metrics such as speed/intensity or the instantaneous calorie consumption rate.

The exercise score 1220 may further separate intensity and form scoring (or scoring for any other set of metrics) for multiple different aspects of a user's performance of a fitness exercise (e.g., form or intensity). In this case, output neurons that are irrelevant for a particular aspect (such as form) may be removed from the softmax computation (see e.g., FIG. 9). By doing this, the probability mass may be re-distributed to the other neurons that are relevant for the considered aspect and the fair scoring approach described previously may be used to obtain a score with respect to the particular aspect at hand.

In another metric example, calories burned 1220 by the user may be estimated. The calorie estimation 1220 may be a special case of the scoring approach described above that may be used to estimate the calorie consumption rate of an individual exercising in front of the camera on-the-fly. In this case, each activity label may be given a weight that is proportional to the Metabolic Equivalent of Task (MET) value of that activity (see references (4), (5)). Assuming the weight of the person is known, this may be used to derive the instantaneous calorie consumption rate.

A neural network head may be used to predict the MET value or calorie consumption from a given training dataset, where activities are labelled with this information. This may allow the system to generalize to new activities at test time.

Referring back to FIG. 12, in one or more embodiments, the at least one head network may comprise a discrete event detection head network 1210 for determining at least one event from the video signal based on a layer of the backbone network, each of the at least one event may comprise an event classification; and the feedback inference comprises the at least one event.

The discrete event detection head 1210 may be used to perform event classification 1216 within a certain activity. For instance, two such events could be the halfway point through an exercise (such as a push-up) as well as the end of a pushup repetition. In comparison to the recognition head discussed above, which typically output a summary of the activity that was continuously being performed during the last few seconds, the discrete event detection head may be trained to trigger for a very short period of time (usually one frame) at the exact position in time the event happens. This may be used to determine the temporal extent of an action and for instance on-the-fly count the number of exercise repetitions 1222 that were performed so far.

This may also allow for a behavior policy that may perform a continuous sequence of actions in response to the sequence of observed inputs. An example application of a behavior policy is a gesture control system, where a video stream of gestures is translated into a control signal, for example for controlling entertainment systems.

By combining discrete event counting with exercise scoring, the network may be used to provide repetition counts to the user where each count is weighted by an assessment of the form/intensity/etc. of the performed repetition. These weighted counts may be conveyed to the user, for example, using a bar diagram 516. This is illustrated in FIG. 5. The metric resulting from a combination of discrete event counting and exercise scoring may be referred to as a repetition score.

The localized activity detection head 1212 may determine bounding boxes 1218 around human bodies and faces and may predict an activity label 1224 for each bounding box, for example, determining if a face is for instance “smiling” or “talking” or if a body is “jumping” or “dancing”. The main motivation for this head is to allow the system and method to interact sensibly with multiple users at once.

When multiple users are present in the video frames 1202, it may be useful to spatially localize each activity performed in the input video instead of performing a single global activity prediction 1220. Spatially localizing each activity performed in the input video may also be used as an auxiliary task to make a global action classifier more robust to unusual background conditions and user positionings. Predicting bounding boxes 1218 to localize objects is a known image understanding task. In contrast to image understanding, activity understanding in video may use three-dimensional bounding boxes that extend over both space and time. For training, the three-dimensional bounding boxes may represent localization as information as well as an activity label.

The localization head may be used as a separate head in the action classifier architecture to produce localized activity predictions from intermediate features in addition to the global activity predictions produced by the activity recognition head. One way to generate the required three-dimensional bounding boxes required for training is to apply an existing object localizer for images frame-by-frame to the training videos. Annotations may be inferred without the need for any further labelling for those videos that are known to show a single person performing the action. In that case the known global action label for the video may be also the activity label for the bounding box.

Activity labels may be split by body parts (e.g., face, body, etc.) and may be attached to the corresponding bounding boxes (e.g. “smiling” and “jumping” labels would be attached to respectively face and body bounding boxes).

Referring next to FIGS. 12 and 13 together, there is shown a steppable convolution diagram 1300 for model 1200, the steppable convolution for determining feedback inferences in accordance with one or more embodiments. Steppable convolution diagram 1300 shows an output sequence and an input sequence. The input sequence may include inputs from various timestamps associated with video frames received. For example, frame 1306 shows the network making an inference output 1302 based on the inputs at time t 1304, input at time t−1 1308, and input at time t−2 1310. The output 1302 is based on a steppable convolution of inputs 1310, 1308, and 1304. The input and output layers as shown in steppable convolution diagram 1300 may correspond to layers in the backbone network, or the at least one detection heads (see FIG. 12).

Steppable convolutions may be used by the model 1200 (see FIG. 12) for processing a video signal, such as a streaming (real-time) video signal. In a case where streaming video is received from a video input device of a user device, the model may continuously update its predictions as new video frames are received. As compared to regular three-dimensional convolutions, which are stateless, steppable convolutions may maintain an internal state that stores past information (such as intermediate video frame representations, or the input representations of video frames themselves) from the input video signal sequence for performing subsequent inference steps. With a kernel of size K (=3 in FIG. 13, i.e., the inference at time t 1302), the last K−1 (=2 in FIG. 13) input elements, including the input at time t−1 1308, and input at time t−2 1310 are required to perform the next inference step and therefore have to be saved internally. Thus, the input representation for the network includes the preceding inputs. Once the new output is computed, the internal state needs to be updated to prepare for the next inference step. In the example below, this means storing the 2 inputs at timestep t−1 1308 and t 1304 in the internal state. The internal state may be the buffer 124 (see FIG. 1).

A wide variety of neural network architectures and layers may be used. Three-dimensional convolutions may be useful to ensure that motion patterns and other temporal aspects of the input video are processed effectively. Factoring three-dimensional and/or two-dimensional convolutions into “outer products” and element-wise operations may be useful to reduce the computational footprint.

Further, aspects of other network architectures may be incorporated into model 1200 (see FIG. 12). The other architectures may include those used for image (not video) processing, such as described in reference (6) and (10). To this end, two-dimensional convolutions can be “inflated” by adding a time-dimension (see for example reference (7)). Finally, temporal and/or spatial strides can be used to reduce the computational footprint.

Referring next to FIG. 14, there is shown a user interface diagram 1400 for temporal labelling for generating a feedback model in accordance with one or more embodiments.

The user interface diagram 1400 provides an example view of a user 1420 completing a physical exercise. The exercise may be yoga, Pilates, weight training, body-weight exercises, or another physical exercise. The example shown in FIG. 14 is that of a pushup exercise.

The user 1420 may operate a software application that includes temporal labelling for generating a feedback model. A user device captures a video signal that is processed by the feedback model in order to generate temporal labels based on the movement and position of the user 1420. The temporal labels may be overlain on the video frames and output back to the user 1420.

Referring to the example shown in FIG. 14, the first video frame 1402 comprises the user 1420 in a pushup position. The temporal labelling interface may be used to assign event tags 1424, 1426, 1428 to specific video frames. The event tags 1424, 1426, 1428 may be assigned based on the movement and position of the user 1420. The first video frame 1402 shows the user 1420 in a position that the temporal labelling interface has identified as a “background” tag 1424. The “background” tag 1424 may be a default label provided to video frames wherein the temporal labelling interface has not identified a specific event.

The temporal labelling interface in video frame 1404 has determined that the user 1420 has completed a pushup repetition. The “high position” tag 1426 has been identified as the event label for video frame 1404.

The temporal labelling interface in video frame 1410 has determined that the user 1420 is halfway through a pushup repetition. The “low position” tag 1428 has been identified as the event label for video frame 1404.

An event classifier 1422 may be shown on the user interface as a suggestion for the upcoming event label to be identified based on the movements and position of the user 1420. The event classifier 1422 may be improved over time as the user 1420 provides more video signal inputs to the software application.

There is shown in FIG. 14 an example embodiment wherein the user 1420 completes a pushup exercise. In other embodiments, the user 1420 may complete other exercises as previously mentioned. In these other embodiments, the event labels for each video frame may correspond to the movements and body positions of the user 1420.

Temporal annotations identifying frame-wise events may enable learning specific online behavior policies. In the context of a fitness use case, an example of online behavior policy may be repetition counting, which may involve precisely identifying the beginning and the end of a certain motion. The labelling of videos to obtain frame-wise labels may be time consuming as it requires checking every frame for the presence of specific events. The labelling process may be made more efficient, as shown in user interface 1400, by using a labelling process that shows suggestions based on the predictions of a neural network that is iteratively trained to identify the specific events. This interface may be used to quickly spot the frames of interest within a video sample.

Referring next to FIG. 15, there is shown a user interface diagram 1500 for pairwise labelling for generating a feedback model in accordance with one or more embodiments.

Multiple video signals 1510 may be output to one or more labelling users through the labelling user interface 1502. The labelling users may compare the multiple video signals 1510 to provide a plurality of ranking responses based upon a specified criterion. The ranking responses may be transmitted from the user device of the labelling user to the server. The specified criteria may include the speed at which the user is performing an exercise, the form of the user performing the exercise, the number of repetitions performed by the user, the range of motion of the user, or another criterion.

In the example shown in FIG. 15, the labelling user may compare the two video signals 1510 and select a user based on the specified criterion. The labelling user may indicate a relative ranking by selecting a first indicator 1508 or a second indicator 1512 with the labelling user interface 1502, wherein each indicator corresponds to a particular user.

The labelling user, after indicating a relative ranking based on the specified criterion, may indicate that they have completed the requested task by selecting “Next” 1518. Labelling users may be asked to provide ranking responses for any predetermined number of users. In the embodiment shown in FIG. 15, twenty-five ranking responses are required from the labelling user. The labelling user interface 1502 may provide a representation of the response number 1516 that the labelling user is currently completing and a percentage 1504 of completion of the ranking responses. The labelling user may look at and/or update previously completed ranking responses by selecting “Prev” 1514. Once the labelling user has completed the required number of ranking responses, the labelling user may select “Submit” 1506.

Referring next to FIG. 17, there is shown a user interface diagram 1700 for real-time interaction and coaching including a virtual avatar in accordance with one or more embodiments.

The user device captures a video signal that is processed by the feedback model described in FIG. 12 as shown in order to generate a virtual avatar. The virtual avatar may be output to the user for the reasons previously mentioned. The virtual avatar may further provide the user with feedback, as previously mentioned.

The user interface may provide the user with a view of the virtual avatar and a time-dimension. The time-dimension may be used to inform the user of the remaining time left in an exercise, the remaining time left in the total workout, the percentage of the exercise that has been completed, the percentage of the total workout that has been completed, or other information related to timing of an exercise.

The present invention has been described here by way of example only. Various modifications and variations may be made to these exemplary embodiments without departing from the spirit and scope of the invention, which is limited only by the appended claims.

### REFERENCES

(1) Towards Situated Visual AI via End-to-End Learning on Video Clips, https://medium.com/twentybn/towards-situated-visual-ai-via-end-to-end-learning-on-video-clips-2832bd9d519f
(2) How We Construct a Virtual Being's Brain with Deep Learning, https://towardsdatascience.com/how-we-construct-a-virtual-beings-brain-with-deep-learning-8f8e5eafe3a9
(3) Putting the skeleton back in the closet, https://medium.com/twentybn/putting-the-skeleton-back-in-the-closet-1e57a677c865
(4) Metabolic equivalent of task, https://en.wikipedia.org/wiki/Metabolic_equivalent_of_task
(5) The Compendium of Physical Activities Tracking Guide, http://prevention.sph.sc.edu/tools/docs/documents_compendium.pdf
(6) Higher accuracy on vision models with EfficientNet-Lite, https://blog.tensorflow.org/2020/03/higher-accuracy-on-vision-models-with-efficientnet-lite.html
(7) Quo Vadis, Action Recognition? A New Model and the Kinetics Dataset, https://arxiv.org/abs/1705.07750
(8) You Only Look Once: Unified, Real-Time Object Detection https://arxiv.org/abs/1506.02640
(9) YOLOv3: An Incremental Improvement https://arxiv.org/abs/1804.02767
(10) MobileNetV2: Inverted Residuals and Linear Bottlenecks, https://arxiv.org/abs/1801.04381
(11) Depthwise separable convolutions for machine learning, https://eli.thegreenplace.net/2018/depthwise-separable-convolutions-for-machine-learning/
(12) TSM: Temporal Shift Module for Efficient Video Understanding https://arxiv.org/abs/1811.08383
(13) Jasper: An End-to-End Convolutional Neural Acoustic Model, https://arxiv.org/abs/1904.03288

We claim:

1. A method for providing feedback to a user at a user device, the method comprising:
providing a feedback model;
receiving a video signal at the user device, the video signal comprising at least two video frames, a first video frame in the at least two video frames captured prior to a second video frame in the at least two video frames;
generating an input layer of the feedback model comprising the at least two video frames;
determining a feedback inference associated with the second video frame in the at least two video frames based on the feedback model and the input layer; and
outputting the feedback inference using an output device of the user device to the user.

2. The method of claim 1, wherein the feedback model comprises a backbone network and at least one head network.

3. The method of claim 2, wherein the backbone network is a three-dimensional convolutional neural network.

4. The method of claim 3, wherein each of the at least one head network is a neural network.

5. The method of claim 4; wherein:
the at least one head network comprises a global activity detection head network, the global activity detection head network for determining an activity classification of the video signal based on a layer of the backbone network; and
the feedback inference comprises the activity classification.

6. The method of claim 5, wherein the activity classification comprises at least one selected from the group of an exercise score, a calorie estimation, and an exercise form feedback.

7. The method of claim 5, wherein:
the feedback inference comprises a repetition score, the repetition score is determined based on the activity classification and an exercise repetition count received from a discrete event detection head; and
wherein the activity classification comprises an exercise score.

8. The method of claim 6 wherein the exercise score is a continuous value determined based on an inner product between a vector of softmax outputs across a plurality of activity labels and a vector of scalar reward values across the plurality of activity labels of the global activity detection head network.

9. The method of claim 4; wherein:
the at least one head network comprises a discrete event detection head network, the discrete event detection head network for determining at least one event from the video signal based on a layer of the backbone network, each of the at least one event comprising an event classification; and
the feedback inference comprises the at least one event.

10. The method of claim 9, wherein:
each event in the at least one event further comprises a timestamp, the timestamp corresponding to the video signal; and
the at least one event corresponding to a portion of a repetition of a user's exercise.

11. The method of claim 10, wherein the feedback inference comprises an exercise repetition count.

12. The method of claim 4; wherein:
the at least one head network comprises a localized activity detection head network, the localized activity detection head network for determining at least one bounding box and an activity classification corresponding to each of the at least one bounding box from the video signal based on a layer of the backbone network; and
the feedback inference comprises the at least one bounding box and the activity classification corresponding to each of the at least one bounding box.

13. The method of claim 12, wherein the feedback inference comprises an activity classification for one or more users, the at least one bounding box corresponding to the one or more users.

14. The method of claim 1, wherein the video signal is a video stream received from a video capture device of the user device and the feedback inference is provided in near real-time with the receiving of the video stream.

15. The method of claim 1, wherein the output device is at least one selected from the group of an audio output device and a display device.

16. A system for providing feedback to a user at a user device, the system comprising:
a memory, the memory comprising a feedback model;
an output device;
a processor, the processor in communication with the memory and the output device, wherein the processor is configured to;
receive, at the user device, a video signal comprising at least two video frames, a first video frame in the at least two video frames captured prior to a second video frame in the at least two video frames;
generate an input layer of the feedback model comprising the at least two video frames;
determine a feedback inference associated with the second video frame in the at least two video frames based on the feedback model and the input layer; and
output the feedback inference to the user using the output device.

17. The system of claim 16, wherein:
the feedback model comprises a backbone network and at least one head network;
the backbone network is a three-dimensional convolutional neural network; and
the at least one head network comprises a global activity detection head network, the global activity detection head network for determining an activity classification of the video signal based on a layer of the backbone network.

18. The system of claim 16, wherein the video signal is a video stream received from a video capture device of the user device and the feedback inference is provided in near real-time with the receiving of the video stream.

19. The system of claim 18, wherein the output device is an audio output device, and the feedback inference is an audio cue for the user.

20. The system of claim 18, wherein the output device is a display device, and the feedback inference is provided as a caption superimposed on the video signal.
